(19) United States
(12) Patent Application Publication
(10) Pub. No.: US 2019/0319311 A1
(43) Pub. Date: Oct. 17, 2019

(54) Lead acid battery with titanium core grids having titanium suboxide coating

(71) Applicant: Eliot Samuel Gerber, Walnut Creek, CA (US)

(72) Inventor: Eliot Samuel Gerber, Walnut Creek, CA (US)

(21) Appl. No.: 15/932,666

(22) Filed: Apr. 17, 2018

(51) Int. Cl. H01M 10/14; H01M 2/16; H01M 2/02

(52) U.S. Cl. CPC H01M 10/14; H01M 2/0267; H01M 2/1673

(57) ABSTRACT

A lead acid electric storage battery uses conventional lead-acid secondary battery chemistry. The battery may be a sealed battery, an unsealed battery or a conventional multi-cell battery. The battery has a set of positive battery grids (plates) which are constructed with a body portion o stamped f thin titanium metal having a thickness preferably in the range 0.1 mm to 0.9 mm and most preferably 3 mm to 4 mm. The titanium is coated, on all sides, with titanium sub-oxide, a conductive ceramic. Typically the battery would have over 250 grids in a 12 inch long battery case.

### BACKGROUND OF THE INVENTION

### Field of the Invention

The present invention relates to lead acid storage batteries, and more especially to the cells for such batteries.

### Description of Related Art

The need for improvements in lead-acid storage batteries is widely recognized. A lead acid electric storage battery uses conventional lead-acid secondary battery chemistry.

Hundreds of articles, patents and research projects have been directed toward improving such batteries. Some of the important characteristics that still need improvement are power density, mechanical ruggedness, long life and multiple cycles (charge-discharge). Some important uses for such improved batteries are in “start stop” cars and electric cars (EV) and plug-in hybrid cars (PHEV).

It is generally believed that automobile batteries have a lifetime of 3, or at most 6 years, and that to have longer life they should have thicker lead positive grids. In contrast, the present invention intends to provide a 10 year lifetime battery using positive grids.

It has been suggested that the power or lifetime of lead acid batteries may be increased by substituting lead plates (grids) with other materials. However, it is believed that almost all commercially available lead acid batteries use lead plates. There are now a number of projects that have been reported to use non-metal battery plates. Firefly Energy has announced it is developing carbon foam plates, see U.S. Pat. Nos. 6,979,513 and 7,033,703. Metal oxides including titanium and tin oxides have also been suggested as additives for lead-acid battery plates. See, for example, Rowlette et al., U.S. Pat. No. 4,547,443, issued Oct. 15, 1985, and Hayfield, U.S. Pat. No. 4,422,917, issued Dec. 27, 1983.

One suggestion is to use lead electroplated on a core of another metal, such as aluminum, copper, steel or titanium. Some of the prior patents and articles about lead-plated cores, or otherwise relevant, are set forth below. All of these patents and articles, and all others cited in this patent application, are included herein by reference.

A series of patents to Rubin uses expanded titanium or titanium alloy positive grids without a lead coating. In U.S. Pat. No. 3,486,940 Rubin discloses a titanium nitride Lore with a gold covering layer; in U.S. Pat. No. 3,615,831 he discloses a similar gold covering layer over a titanium-molybdenum-zirconium alloy core and in U.S. Pat. No. 4,251,608 he discloses a steel or titanium core with a graphite protective coating. See also Rubin U.S. Pat. Nos. 3,798,070 and 3,870,563 and Will U.S. Pat. No. 4,326,017.

Lead is plated on copper in Senoo U.S. Pat. No. 5,223,354; Senoo U.S. Pat. No. 5,093,970; Nann U.S. Pat. No. 4,760,001 and Kiessling U.S. Pat. No. 4,554,228 and Re:33,133. U.S. Pat. No. 4,683,648 to Yeh shows a titanium core electroplated with lead. U.S. Pat. Nos. 5,379,502; 5,339,873; 5,544,681 and 5,411,821 disclose copper or steel or other materials as cores with titanium and lead layers.

U.S. Pat. No. 6,316,148 to Bhardwaj discloses a battery using aluminum foil which is coated with lead. U.S. Pat. Nos. 2,739,997 and 2,713,079 to Carrick disclose aluminum plates electroplated with lead in an aqueous plating bath.

### BRIEF SUMMARY OF THE INVENTION

It is the theory of the invention that the conventional lead positive plates of a car storage battery may be replaced by thin titanium grids having a coating of titanium sub-dioxide of a particular type. The sub-dioxide material is coated with lead. This should provide a battery which may be more powerful. more long lasting and less prone to failure.

### CROSS-REFERENCE TO RELATED APPLICATIONS

This application is partly based upon the applicant's prior United States patent applications as follows: application Ser. No. 12/313,090 (20100092630) filed Nov. 17, 2008 now U.S. Pat. No. 7,732,098 and entitled “Lead acid battery having ultra-thin titanium grids” and application Ser. No. 12/799,734 filed May 3, 2010 (20110033744) and entitled “Long life lead acid battery having titanium core grids and method of their production”,

### DETAILED DESCRIPTION OF THE INVENTION

The preferred coating material is titanium suboxide. This coating material is a ceramic such as ‘Ebonax”™. This material was formerly made by Atraverda Lt. of Great Britain and is presently made by its successor Aqua Metals (Alameda, Calif.) The coating is preferably exclusively of the Magneli phase suboxide of titanium. Its formula is Ti sub.OZn−1 where n is an integer 4 or greater. The integers 7 and 9 are preferred and the integers 3 and 5 are avoided. See U.S. Pat. Nos. 8,119,290 and 5,173,215 and EP 2178799 A1 and WO1988005427A1.

The grid cores are a titanium alloy which is stamped from a titanium roll 0.3 to 0.5 mm thick. The preferred alloys are grades 7 (0.12-0.25 Platinum Pd): Grade 17 (0.05 Pd), Grade 26-28 (Ru). The most preferred are Grades 26/28 (Pt. 0.14 Ru) see US U.S. Pat. No. 6,409,792) because it is relatively low in cost. In theory; in a battery using 240 plates (120 positive and 120 negative) each plate weights 8 gr.

It has proven not feasible to use lower cost expanded metal grids, due to their inherent strain/stress, as they bend and warp in the heat of further process steps. The grid dimensions are shown on grid 13 in FIG. 1 in mm.

The preferred coating method is that of U.S. Pat. No. 5,521,029 (to AT&T). In that process a colloidal dispersion of the titanium dioxide powder is mixed with water and is electrophortic deposited on the titanium alloy core. The grids may then be coated with lead (1-10 mm thick) on all suboxide surfaces, preferably by hot dipping (dipping in liquid lead). Alternatively the lead may be electro-plated. The coating material is a ceramic such as ‘Ebonax”™ The preferred material is titanium suboxide. This material was formerly made by Atraverda Lt. of Great Britain and is presently made by its successer Aqua Metals (Alameda, Calif.) The coating is preferably exclusively of the Magneli phase as suboxide of titanium. Its formula is Ti sub.OZn−1 n is an integer 0.4 or greater. The integers 7 and 9 are preferred and the integers 3 and 5 are avoided. See U.S. Pat. Nos. 8,119,290 and 5,173,215 and EP 2178799 A1 and WO1988005427A1. The grid cores are a titanium alloy which is stamped from a roll that alloy.

In theory in a battery using 240 plates (120 positive and 120 negative) each plate would weigh 8 grams, for a total weight of 8×240=1920 grams=4.23 pounds. The material cost of the grids should be relatively low; for example 240 grids at 10 grams per grid (stamping loss) equal 2400 grams; ti at $10.2 per kilo equals $24.48 and Ru is now $65 an oz. equals (Ru 0.14×2400 gr.=3.36 gr.=0.118 oz×$65.=$7.67) total $32.15 or about 13 cents per grid.

The preferred coating method is that of U.S. Pat. No. 5,521,029 (to AT&T). In that process a colloidal dispersion of the titanium dioxide powder is mixed with water and is electrophortic deposited on the titanium alloy core. The grids may then be coated with lead(1-10 mm thick) on all suboxide surfaces, preferably by hot dipping (dipping in liquid lead). Alternatively the lead may be electro-plated.

This lead acid battery should last longer, cost less and be more powerful than conventional Valve-Regulated Lead Acid (VRLA) batteries. Such a battery should have superior input and output power through a wide state of charge (SOC) range and partial state of charge (PSOC) life. It should also have a life cycle that is at least four times longer and produce more power than conventional battery systems.

This improved battery may be useful as the starting battery in “stop-start” cars in which the motor is shut down when the car stops, for example at stop lights. Such “stop-start” operation saves gasoline and reduced air pollution. This improved battery, in another version, may be a “super-battery” used to drive electric cars (EV) and plug-in hybrid cars (PHEV). This battery should be competitive with Li-Ion and Ni-MH battery packs in energy density at a fraction of their costs.

It is the theory of the present invention that the life-time of positive grids may be extended using a titanium-paladium/ruthanium alloy so they are corrosion resistant.

The difference in temperature under an automobile hood, over a 24 hour period may exceed over 100 degrees F., for example during summer in the desert and night time chill The contraction and expansion of lead battery grids may cause flaking and non-adherence of the battery paste and corrosion of the grids. In the present invention the positive grids are thinner, so they have less bulk expansion/contraction and they are made of titanium, which has a much lower coefficient of expansion with temperature, compared to lead. The thermal expansion of titanium at 25 degrees C. is 8.6 micrometer-1 K−1 and that of lead about 3 times greater. The typical thickness of the titanium core of the grids of the present invention are 0.4 mm and the thickness of a typical lead grid is 1.2 mm, three times the thickness of the titanium grids. Consequently the bulk difference in thermal expansion is that lead grids expand and contract about six times as much as the titanium grids.

In accordance with the present invention positive plates for lead acid storage batteries, either conventional sealed and unsealed lead acid batteries, consist of thin grids having thin titanium core grids.

The titanium core is an alloy containing palladium or/and ruthenium.

It is cleaned and coated and then they are dipped into a hot air leveler to be hot dip coated with lead, preferably 50-200 microns on each side. Preferably the cores are formed from a titanium alloy containing less than 0.9 palladium and/or ruthenium. Most preferably the alloy contains 0.02% to 0.2% ruthanium. Preferably the finished grids are about 0.4 to 0.8 mm thick and may be processed by automated battery paste filling machines. They are the positive grids of the battery.

The negative grids are preferably of the same material and construction. The battery is an energy storage device including at least one titanium core positive electrode, a separator, a casing, and an acid electrolyte. The positive electrode is enveloped in a glass mat separator.

### BRIEF DESCRIPTION OF THE DRAWINGS

In the drawings:

FIG. 1 is a top plan view of a finished positive grid of the present invention.

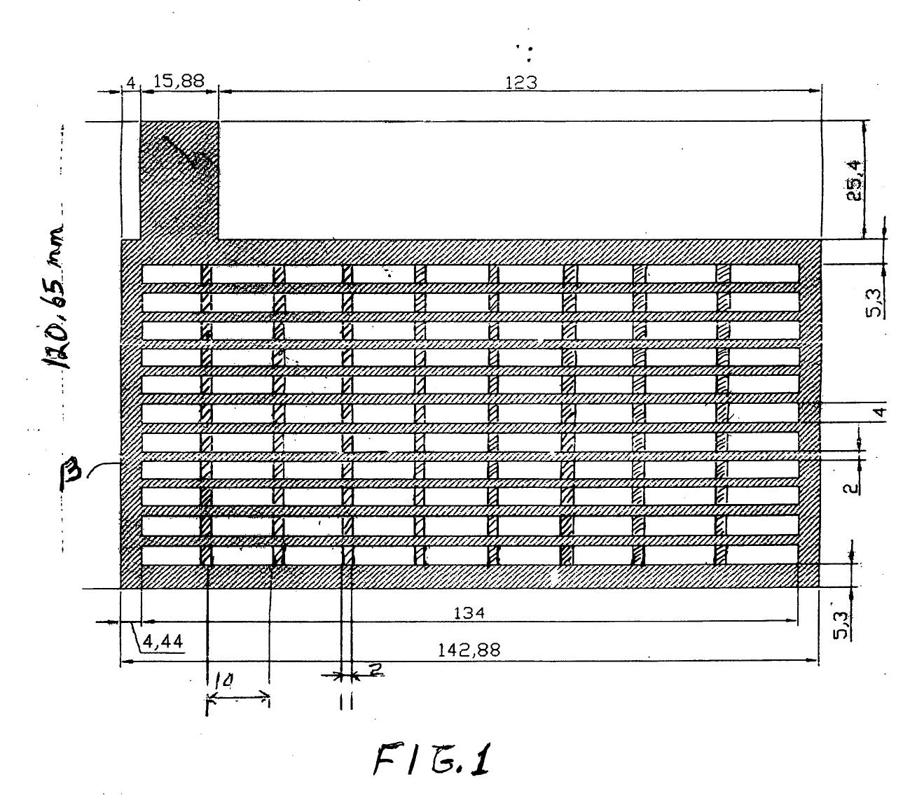

The grid 13 of FIG. 1 is formed from a titanium thin sheet (thin coil). Its thickness, for starter batteries or auto batteries for electric and hybrid cars, is in the preferred range of 0.1 mm to 0.7 mm and most preferably 0.2 mm to 0.4 mm and in any event, less than 0.7 mm. Most preferably the thickness of the core is about 0.3-0.4 mm for those batteries.

The grid 13 of FIG. 1 is formed from a titanium thin sheet (thin coil). Its thickness is in the preferred range of 0.05 mm to 0.9 mm and most preferably 0.4 mm to 0.5 mm and in any event, less than 0.9 mm. Preferably the thickness of the plate is about 0.3-0.4 mm. The grid 13, shown in FIG. 1, is 120.65 mm.high and 142.88 mm. wide. The grids may be thin, for example, as thin as the thickness of the side wall of an aluminum beverage can which has a thickness of about 0.1 to 0.2 mm. Titanium has good electrical conductivity compared to lead; it is stronger than lead; it is lighter than lead; however it is not completely corrosion resistant to the dilute sulfuric acid (“battery acid”) used in lead acid batteries.

The grids are preferably formed from a titanium alloy containing between 0.9% and 0.009% of either ruthenium or palladium or both ruthenium and palladium. The preferred range in the titanium alloy is 0.2% to 0.01% of palladium or ruthenium or both, most preferably 0.2% to 0.02%.

The titanium grids, after forming and cleaning are coated with a protective coating.

What is claimed is:

1. A lead-acid battery comprising a plurality of positive and negative battery grids with separators therebetween: (a) at least some of said positive grids being a titanium alloy (b) said positive titanium alloy grids having a metal body portion and said positive titanium alloy grids having a thickness of less than 1 mm and not being a foil; (c) one of said positive titanium alloy grids forming a plane with an imaginary line perpendicular thereto, said battery having at least 10 of said positive titanium alloy grids perpendicularly aligned along 1 inch (25.4 m) of said imaginary line; and (d) said positive titanium alloy grids including a protective coating of an electrically conductive ceramic of titanium subdioxide Magneli phase whose formula is Tix.On.sub.2n−1 (where n is an integer 7 or 9 (e) and a coating of lead on said titanium subdioxide coating.

2. A lead-acid battery as in claim 1 wherein the lead free titanium alloy positive grids each contains from 0.02% to 0.2% selected from the group consisting of palladium and ruthenium.

3. A lead-acid battery comprising a plurality of positive and negative battery grids with separators therebetween; (a) at least some of said positive grids being lead-free titanium grids; (b) said titanium grids having a metal body portion and said titanium grids having a thickness of less than 0.9 mm and not foil; (c) each of said titanium grids forming a plane having an imaginary line perpendicular thereto, said battery having at least 5 cf said positive titanium grids perpendicularly aligned along 1 inch (25.4 mm) of said imaginary line; wherein the titanium is a titanium alloy containing 0.4% to 0.01% selected from the group consisting of palladium and ruthenium (d) and protective coating of an electrically conductive ceramic of titanium subdioxide Magneli phase whose formula is Tix.On.sub.2n−1 (where n is an integer 7 or 9)

4. A lead-acid battery comprising a plurality of positive and negative battery grids with separators therebetween; (a) at least some of said positive grids being lead-free titanium grids; (b) said titanium grids having a stamped metal body portion and said grids having a thickness of less than 0.9 mm and not being a foil; (c) each of said titanium grids forming a plane having an imaginary line perpendicular thereto, said battery (d) said grids having a protective coating selected from the group consisting of titanium suboxide Magneli phase having the general formula Ti.sub.x O.sub.y, wherein the ratio of y to x is less than 2.selected from the group consisting of Ti.sub.4 O.sub.7, Ti.sub.5 O.sub.9, Ti.sub.6 O.sub.11, Ti.sub.7 O.sub.13, Ti.sub.8 O.sub.15 and Ti.sub.9 O.sub.7. (e) and a coating of lead on said titanium subdioxide coating.
